(19) United States
(12) Patent Application Publication
(10) Pub. No.: US 2008/0203117 A1
(43) Pub. Date: Aug. 28, 2008

(54) Fresh water tote a long

(76) Inventor: Robert L. Townsend, Auburn Hills, MI (US)

Correspondence Address: Robert L. Townsend, 3461 Squirrel Ct, Auburn Hills, MI, 48326, US

(21) Appl. No.: 11/656,615

(22) Filed: Feb. 26, 2007

(51) Int. Cl. B65D 83/00; B67D 5/40

(52) U.S. Cl. 222/394; 222/401; 222/382

(57) ABSTRACT

The subject of this invention is a fresh water refill tank which is used to refill the fresh water tanks on Motor Homes, Fifth Wheels, Travel trailers, and Pop ups. The tank includes either a pump assembly or air pressure assembly to transfer the water from the tank to your motor home, fifth wheel, travel trailer, or pop up. The pump assembly has a pump that sets in the bottom of the tank. With a hose attached from the pump to out side of the tank where a water hose is attached to connect to your motor home, fifth wheel, travel trailer, or pop up. The air pressure assembly is used with air pump to pressurize the tank to push the water thru the siphon tube to the water hose that is connected to your motor home, fifth wheel, travel trailer, or pop up.

The subject of this invention is a fresh water refill tank.

Most motor homes, fifth wheels, travel trailers and pop ups, only have 30 gallons of fresh water. This only last a few days, than you have to refill it. This tank takes care of this Problem.

This tank is used to do this task with out taking down camp. It can also be stored fairly easy in a compartment. The tank is hooked up to your tow vehicle or in the case of a motor home the vehicle that you tow. You take it up to the fresh water station fill it up. Than bring it back to camp and refill the fresh water tank on your motor home, fifth wheel, travel trailer, or pop up. To transfer the water to your tank can be done two different ways. The first is a pump assembly attached to the inside of the tank. The second one is With air pressure assembly that has a valve stem so you can use a air pump to pressurize the tank. There is a siphon hose that goes from the outlet side of the tank to the bottom of the tank. The pump and air pressure assembly should be placed on a 45 degree angle at the handle end of the tank. The reason for it to be on a 45 degree angle is to make it easy to hook up the hoses with out interference from the handle. The pump and air assembles should not be above the top of the tank so that it can be stored with little interference from the hose fittings that you hook the hoses to fill the tank and transfer the water out. The reason for the Pump and air pressure assemblies at the handle end is so that when you are towing it the hose fittings don't get dirty.

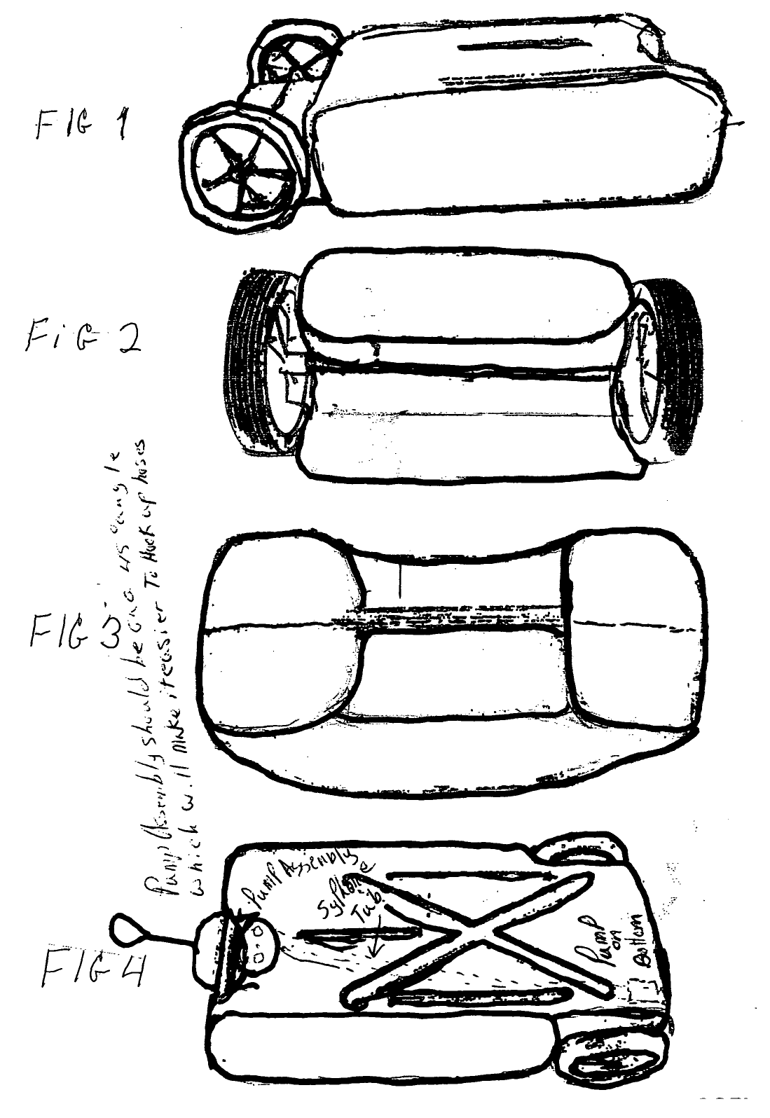

FIG. 1 Shows the bottom and side view of the tank.

FIG. 2. Shows the wheel end of the tank.

FIG. 3 Shows the handle end of the tank. This is the end that is used to tow the tank. It is also where the air and pump assemblies should be mounted on a 45 degree angle.

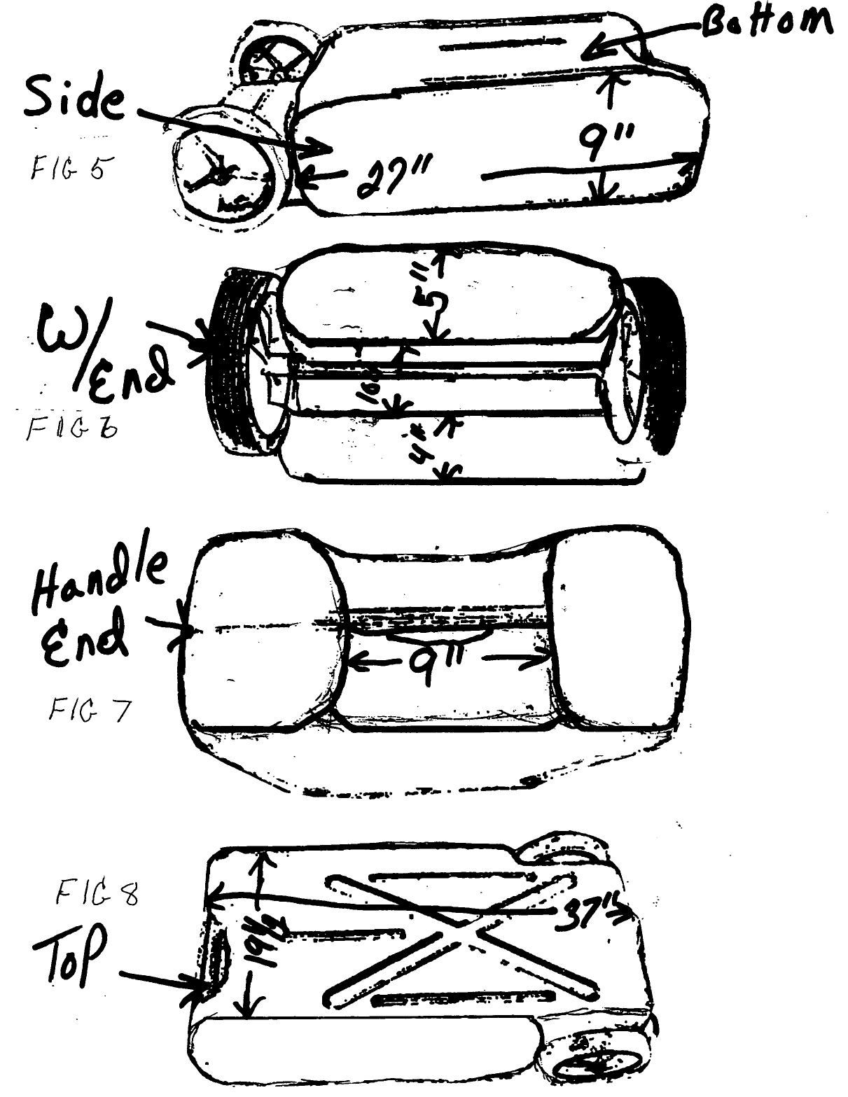

FIG. 4 shows the top and side view of the tank. It also shows the pump assembly with the siphon hose, pump and tow handle.

FIG. 5 Shows the side view dimension of the tank.

FIG. 6 Shows the wheel end dimensions of the tank

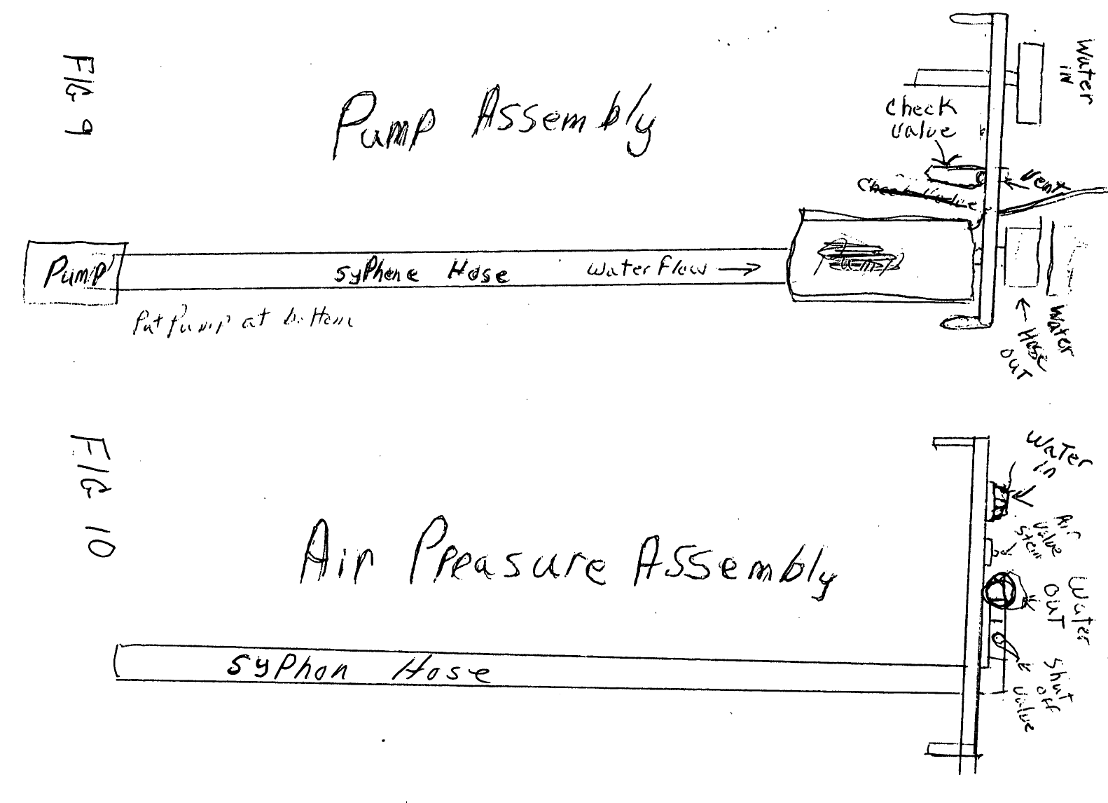

FIG. 7 Shows the handle end dimensions.

FIG. 8 Shows the top of the tank dimensions

FIG. 9 Shows the side view of the pump assembly with the pump and hose fittings. The check valve in the vent is so the water can not spill out while transporting it back to camp. The pump is placed on the bottom so that the vibration from the pump does not crack the top part of the pump assembly.

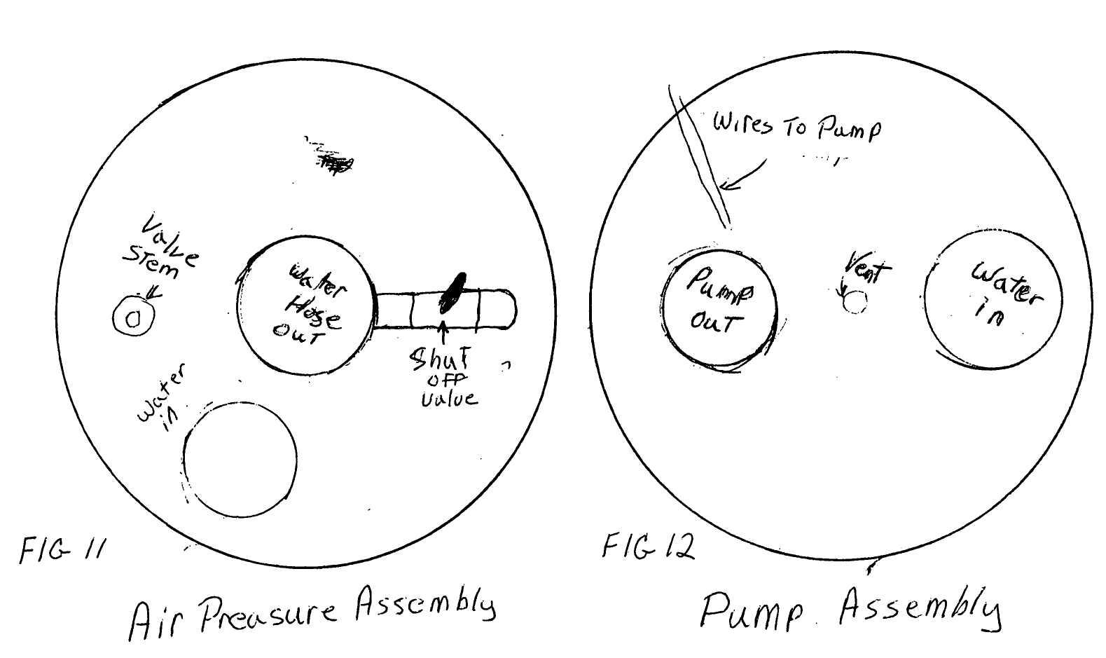

FIG. 10 Shows the side view of the air pressure assembly with the siphon hose and the hose fittings and shut off valve on the out side of the assembly. There is a air valve stem to pressurize the tank. The other fitting is to fill the tank.

FIG. 11 Shows the top view of the air pressure assembly. It shows the shut off valve and the out side male water hose fittings. It shows the valve stem used to pressurize the tank. It also shows the female water hose fitting that is used to fill the tank. There should also be caps and plugs to keep out dirt when not in use.

FIG. 12 Shows the top view of the pump assembly, it shows the two water fittings one is female to fill the tank. The other fitting is a male fitting to pump the water to the fresh water holding tank. It shows the wires to the pump that should have a rubber grommet around them so that is sealed around the wires. It shows the vent that lets in air as you are pumping out the water. There should be caps and plugs for the hose fittings to keep out dirt when not in use.

What is claimed is:

1. A water refill tank to refill the fresh water tank on Motor homes, Fifth wheels, Travel trailers, and Pop ups With either a pump assembled in the tank to pump the water out or an air pressure assembly to do the same thing.

2. A pump assembly is attached to the tank to transfer the water thru a water hose that is connected to the Motor home, Fifth wheel, Travel trailer, or Pop up.

3. A air pressure assembly that has a siphon hose that goes from the bottom of the tank to the out side of the tank where the water hose hooks up that goes to the Fresh water tank on your Motor home, Fifth Wheel, Travel trailer, or Popup. Than you use an air pump to pressurize the tank to push the water out.
